(19) United States
(12) Patent Application Publication
(10) Pub. No.: US 2023/0279825 A1
(43) Pub. Date: Sep. 7, 2023

(54) Multimodal Compressed Air Propulsion Systems for an Aerial Vehicle for Suppressing Widespread Fires

(71) Applicant: Incaendium Initiative Corporation, Richmond, VT (US)

(72) Inventors: Michael Steven Thomas, Richmond, VT (US); Geoffrey Adam Bruder, Rocky River, OH (US); Donna Evelyn Scribner, Center Barnstead, NH (US); Frank Joseph Ritzert, Brunswick, OH (US)

(21) Appl. No.: 18/118,563

(22) Filed: Mar. 7, 2023

Related U.S. Application Data
(60) Provisional application No. 63/317,485, filed on Mar. 7, 2022.

(51) Int. Cl. F02K 1/00; B64U 50/10

(52) U.S. Cl. CPC F02K 1/002; B64U 50/10; B64U 2101/00

(57) ABSTRACT

A multimodal propulsion system of a remotely operated, semi-autonomous, autonomous operated aerial vehicle of a fire-resistant aerial vehicle for suppressing widespread fires deploying hybrid convergent-divergent nozzle systems, electric fans, compressed air subsystems, individually or in combination, primarily powered by ambient air from the fire environment, providing thrust, lift, thrust and lift.

### REFERENCE TO RELATED APPLICATIONS

This application claims priority to the U.S. provisional application No. 63/317,485 filed on Mar. 7, 2022.

### BACKGROUND OF THE INVENTION

Among the challenges of operating a vehicle within an extreme heat environment, for an extended period of time, and for repeated deployments is the ability to reduce or eliminate the use of a flammable or potentially explosive fuel source, or a large battery array, while extending the vehicle's time and range of operation, and using the environment as a fuel and propulsion resource.

Operations of an aerial vehicle within an evolved (wildland) fire environment requires the ability to counter multiple wind patterns.

The current invention will address such challenges.

### SUMMARY OF THE INVENTION

Described herein is a set of novel propulsion techniques for a Fire Suppression System integrated into an unmanned vehicle, either autonomous or remotely operated. The unmanned vehicle may be ground based, aerial, or aquatic. These specialized propulsion mechanisms can function within the high temperatures of an active fire, be it a wildfire or an enflamed building.

An object of this invention is to provide a propulsion mechanism that will provide lift, thrust, and improved maneuverability for operations near, to, and within active fire environment.

Another object is to provide an aerial vehicle with a propulsion system using multiple, independently operable, convergent-divergent nozzles, to effect greater control, maneuverability, safety, and durability when operating contiguous to and within a hostile fire environment where, particularly where it is not uncommon to encounter more than one or multiple wind patterns and airborne debris acting as projectiles.

Another object is to develop an electric driven propulsion system for an aerial vehicle that can be deployed within an active fire environment, whether it is a structural or a wildland fire situation, using ambient air that is then compressed in situ for sourcing a propulsion nozzle subsystem to produce thrust and lift, absent the use of a combustible fuel, combustion engine, or the use of other liquid or solid fuel sources, which otherwise can be applied to systems where the potential of ignition may be critical. Absent the use of combustible fuel, combustion engine, or the use of other liquid or solid fuel sources the current invention will realize zero emission and will not consume resources.

Given the proximity of trees and structures within a forest fire environment to an aerial vehicle operating within same, the ability to rapidly recover from diverse onslaught of differing wind patterns is crucial, not only to perform the intended function of fire suppression and where necessary rescue operations, operational safety of the vehicle, where 720° situational awareness and rapid maneuverability adjustments are requisite not the exception, also safety to System operators, aerial and other vehicles, responders and civilians, and wildlife.

When activated the propulsion systems will provide thrust and lift to counter crosscurrents, updrafts, down drafts, and other wind patterns of a fire environment. For example, where accelerators and other onboard sensors indicate the approach of a rapid updraft, and crosswinds from the left side of the vehicle, rotating winds, the Command Module will activate the centerline, lateral, and fuselage top propulsion systems providing thrust as needed to counter the exerted force against the vehicle to hold and maintain its position, and maneuver by controlling roll, pitch and yaw to achieve proper directionality within the fire environment instead of being at the complete mercy of the winds.

A convergent divergent nozzle is used to accelerate a hot, pressurized gas passing through it to a higher speed in the axial (thrust) direction, by converting the heat energy of the flow into kinetic energy.

Its operation relies on the different properties of gases flowing at low-velocity to high-velocity speeds, based upon Bernoulli and Venturi principles. The speed of a low-velocity flow of gas will increase if the pipe carrying it narrows because the mass flow rate is constant. Typically used in rocket and fighter jet engines, the gas that flows through a de Laval nozzle is isentropic adiabatic, as heat loss here is either zero or near zero.

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications in the described embodiments, and any further applications of the principles of the disclosure as described herein are contemplated as would normally occur to one skilled in the art to which the disclosure relates

### BRIEF DESCRIPTION OF THE DRAWINGS

FIG. 1 depicts a frontal view of the wide body circular fuselage.

FIG. 2 is a partial top view of the wide body aerial vehicle.

FIG. 3 is a basic outline of a Convergent Divergent Nozzle.

FIG. 4 is a convergent Divergent Propulsion Nozzle subsystem, pneumatic compressor subsystem, showing the air flow pattern.

FIG. 5 is a cross-sectional view of a Convergent Divergent Propulsion Nozzle array showing the air flow pattern.

FIG. 6 is a cross-sectional view of a Convergent Divergent Propulsion Nozzle array, showing the air flow pattern.

FIG. 7 is a cross-sectional view of a concentric Convergent Divergent Propulsion Nozzle array with a single secondary pneumatic air bladder.

FIG. 8 is a partial, cut-away view of the concentric Convergent Divergent Propulsion Nozzle with a single secondary pneumatic air bladder and pneumatic air flow control subsystem.

FIG. 9 is a partial, cut-away view of the concentric Convergent Divergent Propulsion Nozzle with multiple independent secondary pneumatic air bladder and pneumatic air flow control subsystems.

FIG. 10 is a cross-sectional of a concentric Convergent Divergent Propulsion Nozzle array with multiple, independent, pneumatic air bladders.

FIG. 11 is a cross-sectional view of a concentric Convergent Divergent Propulsion Nozzle array and air flow pattern, with a variable nozzle attached.

FIG. 12 is a cross-sectional view of a concentric Convergent Divergent Propulsion Nozzle array and air flow pattern.

FIG. 13 is a cross-sectional view of a concentric Convergent Divergent Propulsion Nozzle array with a flexible extension nozzle.

FIG. 14 is a cross-sectional view of a concentric Convergent Divergent Propulsion Nozzle array with an activated flexible extension nozzle.

FIG. 15 is a cross-sectional view of a concentric Convergent Divergent Propulsion Nozzle array with an attached bypass nozzle subsystem.

FIG. 16 is a cross-sectional view of the air flow pattern through a concentric Convergent Divergent Propulsion Nozzle array, the attached air bypass array.

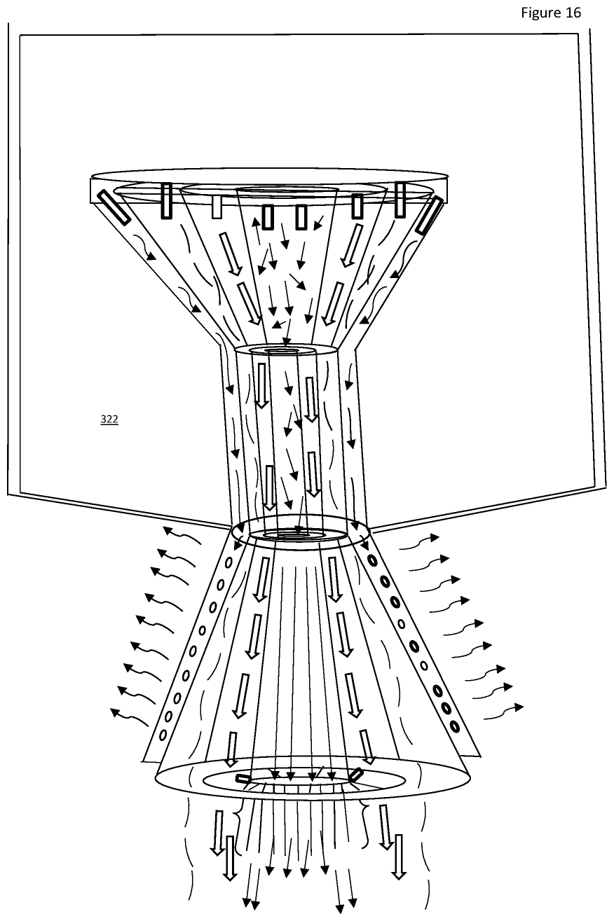

FIG. 17 is a cross-sectional view of a concentric Convergent Divergent Propulsion Nozzle array with a detached air bypass nozzle subsystem.

FIG. 18 is a cross-sectional view of the air flow for the concentric Convergent Divergent

Propulsion detached nozzle subsystem.

FIG. 19 is a pneumatic air compressor for a concentric Convergent Divergent nozzle array further demonstrating the pathway of the attached and detached air bypass subsystems.

FIG. 20 is a propulsion nozzle subsystem with an electric fan.

FIG. 21 is a propulsion nozzle subsystem with an electric fan.

FIG. 22 is a propulsion nozzle subsystem with a secondary pneumatic air pump.

### DETAILED DESCRIPTION OF THE PREFERRED EMBODIMENTS

Hereinafter, this invention will be described in the presently preferred embodiments and the associated drawings.

The Command Module in this invention is electronically or wirelessly linked to the Urban Traffic

Management systems, Beyond Visual Line of Sight systems, microwave systems, infrared, near-red, LIDAR, GPS, Altimeter, communication systems, gyroscope, collision detection/situational awareness sensors, pressure sensors, geofencing sensors, air pressure relief system, structural integrity monitor devices, pneumatic air intake, compressor and air flow monitors and control mechanisms, air flow monitor of the convergent divergent nozzle system, flame detection, thermal detection, collision detection and avoidance, internal and external environment temperature monitors, electrical generation and distribution, battery usage and charging, filtration, propulsion systems, microelectrical mechanical systems, thermal storage, thermal transfer, cooling systems, Radio Frequency Identification, flight controllers, accelerometers and other devices, systems, and apparatus, where data from onboard systems is utilized by the Command Module to activate and adjust each propulsion system to meet the stability demands required to operate the vehicle.

The Command Module preferably comprises a control unit, configured to control operations of the device. For example, the control unit comprises a computing device and/or an integrated circuit. The control unit comprises a processor, such as a microcontroller.

Each propulsion subsystem is electronically connected with a pressure sensor, air pressure relief system, structural integrity monitor devices, pneumatic air flow monitor, and control mechanism. Placement, calibration, programming, and data usage of such devices will be determined later, not here, but appreciated by one skilled in the art.

The number of propulsion systems employed, specific type and placement to the vehicle to be determined during manufacturing where the size, configuration, and specific design of the vehicle is determined, not shown here.

Whether using a turbofan, turboprop, rotor, turbojet the purpose is to produce enough thrust and lift to propel an aircraft The impact of ejecting water and air through a water jetpack or water jets of a watercraft, essentially to effect propulsion. Rockets, and missiles are designed to push compressed gas resulting from combusted fuels through a nozzle, wherein exhausted gas is expelled at low pressure, high velocity, exiting a nozzle to the environment, using conservation of momentum and mass to provide thrust. One such nozzle through which compressed exhaust gas is ejected is a Convergent Divergent Nozzle.

Each air duct or line of this invention is additionally fitted with a pneumatic air backflow preventer. The backflow preventer and solenoid of the compressor intake lines may be fitted at or in closer proximity to where the pneumatic air line is connected to the pneumatic air compressor and may require a diameter that is four times to ten times greater than the pneumatic air line itself to ensure laminar flow. The intake of air is required to be at a rate higher or equal to the flow rate of air that is expelled.

A protective cage, or mesh of large enough coarseness to not substantially impede pneumatic airflow, where the propulsion system or a part thereof is directly exposed to the external environment can be affixed to the vehicle to prevent external or environmental debris impacting, blocking, or otherwise interfering with operation of a given propulsion subsystem.

This invention will employ, but not discuss, the use of thermal insulating materials to stem heat transfer from the exterior surfaces of the invention toward the more temperature-sensitive interior elements. Insulative materials and the architecture of the insulating media are employed, in concert, to control overall thermal protection in the invention. An array of sensors will assess necessary temperature controls in real-time. Strategic arrays of highly conductive materials may be integrated into the invention to preferentially direct heat toward external surfaces of the invention.

The material concepts/group comprised of this invention, though not limited to, one or more of the following: ultra-high temperature ceramics (UHTC), refractory metals/alloys, carbon fiber composites, C/SiC, SiC/SiC, coated C/C, metal matrix composites, ceramic matrix composites, ceramic matrix ablators, carbon ablators, carbon-carbon ablators, aerogels, polymer matrix composites, silicates, silicides, graphites, graphene, borides, carbides, high-enthalpy alloys, MAX alloys, stainless steels, titanium alloys, aluminum alloys, superalloys, steels, wrought alloys, cast alloys, additively manufactured alloys, and abradable materials, and low-density rock materials such as steatite and lava rock. Materials definitions will withstand up to 1650C temperatures in heavily oxidizing and carbon dusting environments; an impact resistant covering or coating that impedes/eliminates projectile damage to areas of the propulsion system exposed to the external surface of the outer vessel. Such concepts include diverting potentially damaging articles away from surfaces.

Sensors would be integrated into the protective concepts such that critical damage thresholds would be detected to prompt vehicle exit from service to avoid catastrophic loss. Protective architectures for external surfaces may include any combination of screens, pins, fins, plugs, engineered surface angles, nodules, abradable/sacrificial materials. Actual shape, thickness, and dimensions of the convergent divergent nozzle that allow for a variation of diameter, as external conditions will change rapidly and the flow conditions may not be achievable with pressure alone with a fixed geometry, its associated pneumatic air compression system, will be determined by those skilled in the art during design dependent upon a number of factors including but not limited to payload; suppression system type, size, and weight; vehicle dimensions; thrust requirements; number of propulsion systems per vehicle, applying Bernoulli's and Venturi's principles, and de Laval formulas, respectively. The actual number, placement, and type of propulsion subsystems outlined in this invention will be determined during design, dependent upon the size, dimensions, and payload of the vehicle.

Utilization of heat pipes, thermosiphons, and similar art known to the heat management technical community will provide temperature controls in the component such that material property limits, both physical and mechanical, will not be exceeded.

Electrical onboard power that is necessary for invention operation is generated through the conversion of heat energy to electrical energy. The inventive vehicle scavenges and/or searches for and collects heat from the fire environment and converts it to electricity through Thermoelectric, Thermoacoustic, Thermophotovoltaic, fuel cells, Stirling, microwave, or other energy conversion state-of-the-art either possessed in the open literature or with the inventor. Actual type, size, number of device(s), required electrical load, how connected, controlled, and placement to the vehicle to be demonstrated where the size, configuration, and specific design of the vehicle is determined, not here. The flight control system may contain an autonomous software and software programming for controlling precise flight operations of the apparatus.

The compression of air will be undertaken by the ingestion of external air into the pneumatic air compressors for subsequent compression into pneumatic air bladders.

The Command Module utilizes data and programmed information based on data collected from one or more sensors (e.g., infrared sensor, temperature sensor). The processing of methods and systems can be performed by software components and can be described in the general context of computer executable instructions, such as program modules, execution by one or more computers, computing devices, or other devices. The system memory further comprises computer readable media in the form of volatile memory, such as random-access memory, and/or non-volatile memory, such as read only memory, and other removable/non-removable, volatile/non-volatile computer storage media. The system memory typically contains data such as the signal selection data and/or program modules such as an operating system and the signal selection software that are immediately accessible to and/or are presently operated on by the one or more processors.

The engine configuration of the present invention can perform the horizontal rotational turn of a rotor-based vehicle, and VTOL and self-righting function when the vehicle is overturned in flight.

The Pneumatic Air Compression Propulsion Subsystem has one or multiple high PSI high volume pneumatic air compressors with pneumatic air intake lines that extend from the exterior surface of the vehicle to one or more flexible, pneumatic air bladders (hereinafter, primary bladders), with one or more pneumatic air flow control and air pressure control valves to pneumatic air outflow ducts or lines with an pneumatic air flow control system, that when activated by the Command Module will open a pneumatic air valve to allow the flow of air from the ambient environment for compression then containment within the primary bladder for regulated air flow release through propulsion subsystem nozzles.

When the required volume of air and air pressure is achieved within the primary bladder, based upon prior programming of the Command Module, and data from sensors used by the Command Module, along with computer algorithms to determine flight requirements of the vehicle, the Command Module will open one or more pneumatic air valves for the flow of air through its connection to one or more ducts or lines connecting it to either a pneumatic air flow control apparatus of the propulsion nozzle of a secondary bladder or in the alternative directly to a propulsion nozzle through a pneumatic air out flow solenoid fitted with a pneumatic air backflow preventer.

The primary bladder can be fitted within the interior framework of the vehicle, that when inflated by the pneumatic air compressor(s) will expand within but not exceed design specifications of the pneumatic air bladder nor the airframe of the vehicle. Sensors monitoring pressure, volume, temperature of air contained therein and temperature of the bladder, air outflow directly to either the propulsion subsystem nozzle(s) or to the propulsion nozzle pneumatic air flow control apparatus and thrust requirements will be used by the Command Module to modify the rate of pneumatic air compression and pneumatic air flow to meet propulsion demands and vehicle stabilization.

The primary and secondary bladders, pneumatic air control apparatus, pneumatic air intake and pneumatic air outflow lines, control systems, valves, solenoids may be constructed of a polypropylene, polyethylene, nylon, olefin, PVC laminated or coated fabric, cloth-back vinyl, thermoplastic films, ethyl vinyl acetate, thermoplastic polyurethane, elastomers, silicon carbides, advanced ceramic materials, C/SiC, SiC/SiC, coated C/C, metal matrix composites, ceramic matrix composites, polymer matrix composites, silicates, silicides, borides, carbides, high-enthalpy alloys, MAX alloys, stainless steels, titanium alloys, aluminum alloys, superalloys, steels, wrought alloys, cast alloys, additively manufactured alloys, abradable materials, cermets or other extreme temperature resistant materials. Coatings and surface preparations that change the boundary layer conditions such that environmental attack is not energetically favorable. Such architectures include, but are not limited to, surface topology characteristics, surface tribological characteristics that change the physical properties of the surface or other flow-path altering constructs.

Each vehicle may be fitted with a unitary pneumatic or multiple primary bladders. Two or more primary bladders may be interconnected by one or more pneumatic valves and/or ducts or lines equipped with a Command Module controlled pneumatic air solenoid valves. Each primary bladder can be connected to one or more pneumatic air compressors, which can have one or more pneumatic air intake lines that extend to the exterior surface of the vehicle to facilitate the flow of ambient air to one or more pneumatic air compressor when activated by the Command Module.

Pneumatic air intake lines extending from the surface of the vehicle to the pneumatic air compressor, from the pneumatic air compressor to the primary bladder, from the primary bladder to the propulsion nozzle system, and from the primary bladder to the secondary bladder, are designed to expand to adjust for air pressure, volume or flow rate, heat, which may exceed the normal range of tolerance by a design.

The propulsion nozzle subsystem utilizes compressed air as the force to create thrust and lift. Each propulsion subsystem can be fitted with one or more primary bladders connected to one or more convergent-divergent propulsion nozzle systems.

The propulsion nozzle subsystem utilizes compressed air as the force to create thrust and lift. Each propulsion subsystem can be fitted with one or more secondary bladders. The flow of compressed air from the secondary bladder can be achieved by direct flow through pneumatic air solenoids with a pneumatic air backflow preventer to the nozzle or to a pneumatic air flow control apparatus constructed as part of the propulsion nozzle or detached from same with a connection from the pneumatic air flow control apparatus of the secondary bladder by the Command Module that controls the pneumatic air solenoids extending from the pneumatic air flow control apparatus to a propulsion nozzle. Sensors monitoring pressure, volume, temperature of air contained therein and temperature of the bladder, pneumatic air outflow directly to either the propulsion subsystem nozzle(s) or to the propulsion nozzle pneumatic air flow control apparatus and thrust requirements will be used by the Command Module to modify the rate of air compression and pneumatic air flow to meet propulsion demands and vehicle stabilization.

The propulsion nozzle pneumatic air flow control apparatus may consist of either a rigid pneumatic air containment structure or an expandable secondary bladder that meet at minimal all ASME Boiler Code requirements and are connected to one or more ducts or lines extending from the primary bladder to and within the pneumatic air flow control apparatus. The pneumatic air line that enters the pneumatic air flow containment apparatus, coiled or serpentine fashion and of an expandable material, will allow the pneumatic air line to expand as needed to accommodate material expansion resulting from varying temperature and pressure conditions, decompression, and repeated pressurization. Command Module electronically or wirelessly linked sensors monitor heat, pressure, and pneumatic air flow to prevent over pressurization within the pneumatic air flow control apparatus and the ducts or lines.

The CFM flow from the primary bladder to the pneumatic air flow control apparatus must be sufficient to maintain a constant high PSI to meet the volume and pressure of air flowing through the propulsion nozzle to meet Command Module determined propulsion requirements.

Pneumatic air flow regulators and pneumatic air pressure regulators are electronically or wirelessly linked to the pneumatic air solenoid(s) for the Command Module to monitor and control pneumatic air flow and pressure.

During pre-flight, the primary bladder may be loaded with compressed air by the vehicle's

Command Module activated pneumatic air compression and bladder subsystems as well from a launch vehicle, static/ground-based system, aerial or marine vehicle, or other platform with capacity to compress air to the level of volume/pressure required by the vehicle and within predetermined time constraints, or for VTOL and STOL flight.

Wide Body Circulator Fuselage

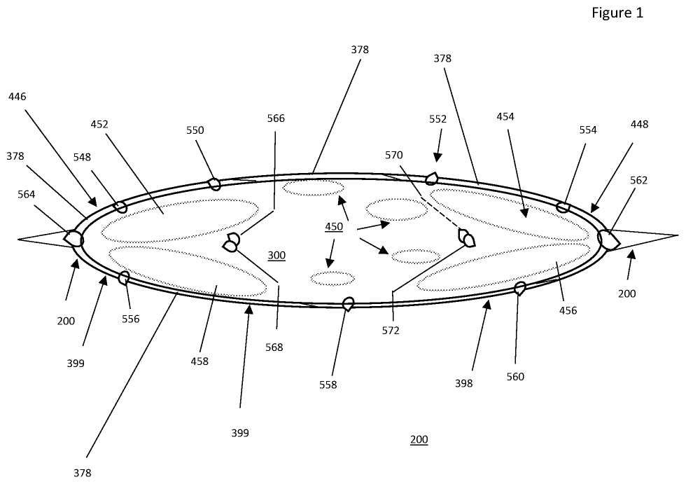

In an embodiment, FIG. 1 shows a frontal, cross section view of the wide body, circular fuselage, circular wing aerial vehicle (300) where beginning with the fuselage top left side (446), moving to the fuselage top right side (448) is fitted with multiple, independent Command Module controlled propulsion subsystems (548, 550, 552, 554). The fuselage undercarriage (399, 398) of the vehicle is further fitted with multiple independent Command Module controlled propulsion subsystems (556, 558, 562) that extend to or to the exterior of the vehicle's exterior surface (200). Additional independent Command Module controlled centerline front and rear propulsion subsystems are noted (566, 570, 572), and lateral propulsion subsystems (564, 562, 568, 572).

Fires, particularly wildfires create a weather pattern different from what is generally encountered elsewhere. It is not uncommon to encounter more than one wind pattern within a fire environment. Add to this super-heated air, the explosive ignition of vegetation above, below, to the fore and aft of the vehicle, crosscurrents, updrafts, down drafts, and other patterns, which are not common to autonomous and remote-controlled aerial vehicles operating outside of hostile environments. Given the proximity of trees and structures within a fire environment to an aerial vehicle operating within same, the ability to rapidly recover from diverse onslaught of differing wind patterns is crucial, not only to the operational safety of the vehicle, but to fire management/suppression, other aircrafts, and people. The Command Module, linked to flight controls and sensor systems, using onboard data, and associated algorithms, will determine the necessary propulsion system adjustments to the requisite thrust and lift against, for example, countervailing wind conditions.

The distance which may be afforded an aircraft with the standard placement of engines, to turn or avoid an obstacle in an open air, unobstructed flight situation, at five knots per hour or several hundred knots per hour, is far more forgiving than what can be accomplished within the close quarters of fire environment. For an aerial vehicle to overcome this limitation while operating within the fire environment, and to provide greater stability and maneuverability, this invention is fitted with multiple propulsion subsystems, which can be operated independently and in concert, that when activated will provide thrust and lift to counter crosscurrents, updrafts, down drafts, and other wind patterns of a fire environment. For example, where onboard sensors indicate the approach of a rapid updraft, and crosswinds from the left side of the vehicle, and rotating winds, the Command Module can activate the centerline (566, 570), lateral (562), and fuselage top propulsion (548, 550, 552, 554) subsystems providing thrust as needed to counter the exerted force against the vehicle, to hold and maintain its position, and maneuver within instead of being at the mercy of the fire environment's winds.

The propulsion subsystems (548, 550, 552, 554, 556, 558, 562,564, 566, 560, 570, 572) and fire suppression subsystems (452, 454, 456, 458) of this invention are powered by Command Module controlled onboard electric generators (450).

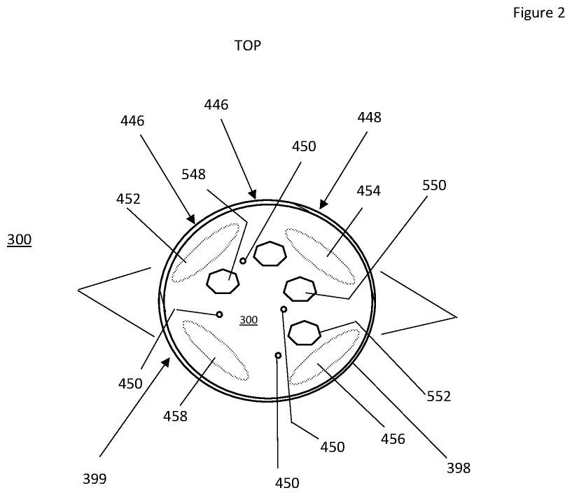

In another embodiment of FIG. 1, FIG. 2 is a top view of the vehicle (300) showing the left (446) and right (448) top fuselage with multiple propulsion subsystems (548, 550, 552, 554, 452, 454), Command Module controlled electric power generation subsystems (450), and fire suppression subsystems (452, 454, 456, 458).

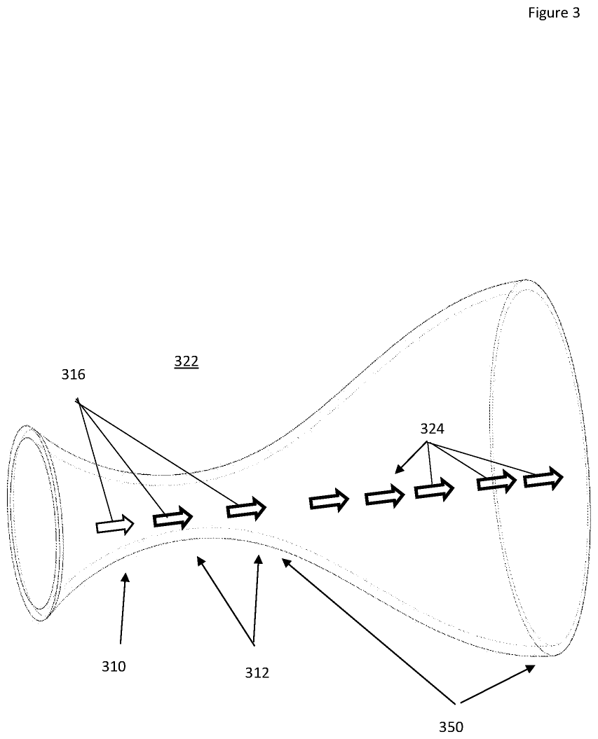

In another embodiment, FIG. 3 is a basic outline of a Convergent Divergent Nozzle (360). Gas under pressure is injected into the convergent section of the nozzle, creating a High-pressure Low-velocity flow. Pressurized gas continuing to flow through the divergent section of the nozzle exits therefrom to the ambient environment. Exit air flow from the divergent section is at Low-pressure High-velocity.

Convergent-Divergent Propulsion Subsystem

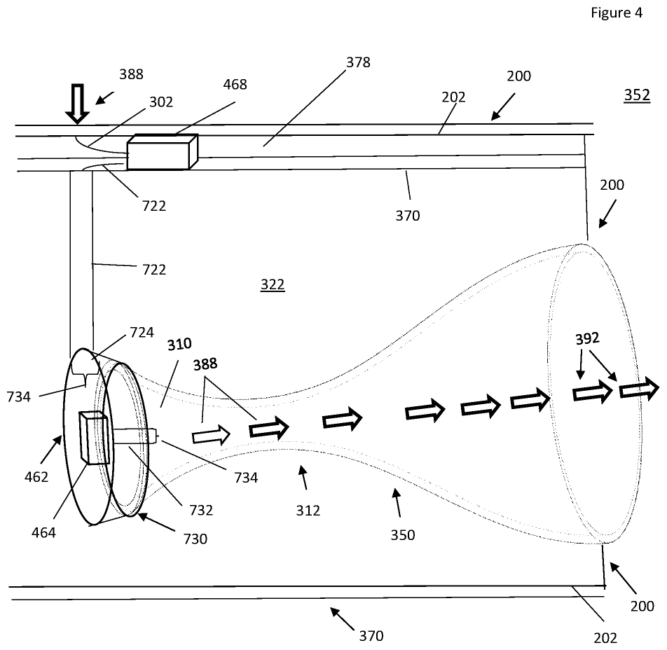

In an embodiment, FIG. 4 demonstrates a Convergent Divergent Propulsion Subsystem (322) fitted with a secondary bladder (hereinafter referred to as the secondary bladder) (462) that contains a pneumatic air flow apparatus (464) connected to a pneumatic air outflow line (732) that has a pneumatic air backflow preventer solenoid (734) that exits within the convergent section (310) of the Convergent Divergent Propulsion subsystem nozzle (360).

Convergent-Divergent Propulsion And Pneumatic Air Subsystems

As shown, the Convergent Divergent Propulsion Nozzle subsystem (322) of FIG. 4, is fitted within a housing system (370). The Convergent Divergent Propulsion Nozzle subsystem is fitted within the vehicle (200). The vehicle (200) here further contains one or more pneumatic air intake lines (320) that extend from the vehicle's exterior surface to one or more primary pneumatic air compression pumps (468). The Command Module, when activated, will cause the air valve of the pneumatic air line at the surface of the vehicle to of whereby the pneumatic compression pumps will draw ambient air into the primary bladder (hereafter referred to as the primary bladder (378). A Command Module regulated volume of compressed air can then be pumped by the pneumatic air compressor (378), through one or more pneumatic primary air compressor outflow air lines (722), through a pneumatic air line that has a backflow preventer (724), into one or more secondary bladder(s)(462) of the Convergent Divergent Propulsion Nozzle system (722). The primary bladder (378) is fitted within the airframe (202) of the vehicle (200). The secondary bladder (462) is fitted with a Command Module controlled pneumatic air flow apparatus (464) that will release a controlled volume of compressed air through its pneumatic air solenoid (372) that has an air backflow preventer (374), into the convergent section (310) of the Convergent Divergent Propulsion Nozzle under high pressure. That volume of compressed air released into the convergent section (310) of the Convergent Divergent Propulsion Nozzle under high pressure will flow through the throat section of the Convergent Divergent Propulsion Nozzle (312), exiting to the ambient environment (350). As shown in FIG. 4, the secondary air pneumatic bladder (462) is connected by an out-flow line (722) with an air solenoid that extends from the primary air pneumatic bladder (378), that upon activation of the Command Module will result in flow and pressurization of the secondary bladder. The primary air pneumatic bladder (378) is fitted to and within the airframe of the vehicle (200).

The primary bladder (378) is connected to one or more primary pneumatic air compressors (468), with one or more pneumatic air intake lines (302) that extend to and through the surface of the vehicle (200) to the exterior environment, that when activated by the Command Module ambient air (388) entering though a pneumatic air intake line (302) is compressed into the primary bladder subsystem (378) by one or more pneumatic air compressors (468).

To effect flight the Command Module will open the ball, butterfly, or needle valve of the primary bladder out-flow line (722) to cause the requisite volume of air under pressure through a pneumatic air flow control apparatus (464) to flow to a secondary pneumatic air containment apparatus (here, a secondary bladder) (462). The secondary bladder contains a Command Module controlled pneumatic air flow control apparatus (306) that will stream a volume of air under high pressure into the convergent section of the Convergent Divergent nozzle.

The pneumatic air out flow line extends from the pneumatic air flow controller (464) of the secondary bladder (462), passes through an interface (730) of the secondary bladder, into the convergent section (310) of the Convergent Divergent Nozzle, has a Command Module controlled pneumatic air solenoid (734) terminating therein.

Multiple primary bladders (378) are deployed to maintain a volume of air and at a pressure greater than the total propulsion requirements of the vehicle at a given time in flight.

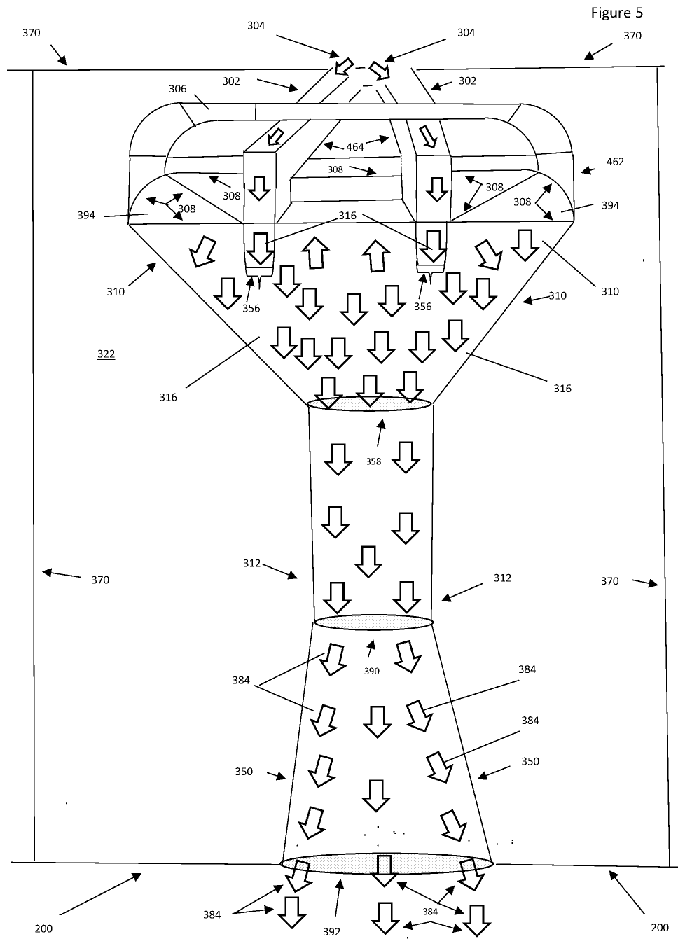

In another embodiment of FIG. 4, FIG. 5 is an aerial vehicle propulsion subsystem (322) utilizing compressed ambient air injected through a Convergent Divergent nozzle subsystem to provide thrust and lift to the vehicle. As shown here, the Convergent Divergent nozzle subsystems (322) of this vehicle are separately housed (370) for incorporation into and/or attached to the body of the vehicle. However, independent housing, incorporation into the body of the vehicle is not a pre-requisite for utilization and operation of this Propulsion Subsystem.

This embodiment depicts the Convergent Divergent Propulsion Subsystem (322) where starting from the top of the figure and working downward, pneumatic air out flow lines (302) extend from the primary bladder and its pneumatic air flow control apparatus through the housing (394) of the secondary bladder (462) thereafter into the pneumatic air compression apparatus (306), thereafter into a secondary bladder pneumatic air flow control apparatus (306). The primary bladder air out flow line (302) is fitted with an air valve that is further fitted with an air backflow preventer.

When activated by the Command Module a butterfly, needle, or ball valve pneumatic air line will open, allowing the activated secondary bladder pneumatic air flow control apparatus (464) to draft in compressed air from the primary bladder (not shown) into the secondary bladder (462) and its pneumatic air flow control apparatus (464) at a rate greater than what is expelled through the propulsion subsystem nozzle. Air is continually compressed and injected through a pneumatic air out flow line of the secondary bladder's pneumatic air flow control apparatus and into the convergent section (310) of the Convergent Divergent nozzle. The pneumatic air out flow line that extends from the primary bladder and its pneumatic air flow control apparatus to and within the secondary bladder and its pneumatic air flow control apparatus can be a high heat resistant metal tubing (or other material discussed above as to the material concepts/group) with a loop to allow for expansion resulting from extreme heat, pressure and the continuous of compressed hot air through same. As depicted here in the embodiment of FIG. 5, the now compressed ambient air (316) is ejected through the solenoid (356) into the convergent section (310) of the Convergent Divergent Propulsion Nozzle subsystem (322) as a high-pressure low velocity air flow (316). That air flow then passes through the connected section (358), of the throat (312) that is connected (390) to the divergent section (350) of the Convergent Divergent Propulsion Nozzle subsystem. That air flow then passes, with sufficient pressure and speed through the throat section of the Convergent Divergent Propulsion Nozzle subsystem connected to the divergent section (350) of the Convergent Divergent Propulsion Nozzle subsystem, now as a low-pressure high velocity air flow (384), thereafter exiting (392) the distal section of the Convergent Divergent Propulsion subsystem's nozzle section (350) to the ambient environment, creating thrust and lift.

Here, FIG. 5 is shown with two secondary bladder and pneumatic air flow control apparatus (464) and attached (308) to the Convergent Divergent propulsion subsystem nozzle (310), the depiction here is not an intended limitation.

The propulsion subsystem nozzles can be constructed with one or multiple pneumatic air out flow lines that extend from the primary bladder to the secondary bladder, one or multiple secondary bladders and pneumatic air flow control apparatus, as a unitary structure, or where the secondary bladder and pneumatic air flow control apparatus are separated from the Convergent Divergent propulsion subsystem nozzle but attached by pneumatic out flow ducts or pneumatic air lines extended from a secondary bladders and pneumatic air flow control apparatus, to the convergent end of the Convergent Divergent Propulsion Nozzle.

Each propulsion subsystem nozzle is equipped with (not shown here) a pneumatic air pressure sensor, pneumatic air relief valve, and a structural integrity monitor. Data from these devices will be processed by a Command Module for operation of propulsion subsystems.

At sufficient volume air injected into the convergent section of the nozzle (310) will create a High-pressure Low-velocity flow (316). Compressed air of sufficient volume, ejected through the interior (624) Convergent-Divergent propulsion subsystem nozzle that is coaxially disposed upstream within the exterior of the Convergent Divergent Propulsion Subsystem Nozzle (424), entering the divergent section of the propulsion subsystem nozzle (350) will exit as Low-pressure High-velocity (384) air flow, exiting (392) the divergent section (350) to the external environment to create thrust, lift, or both.

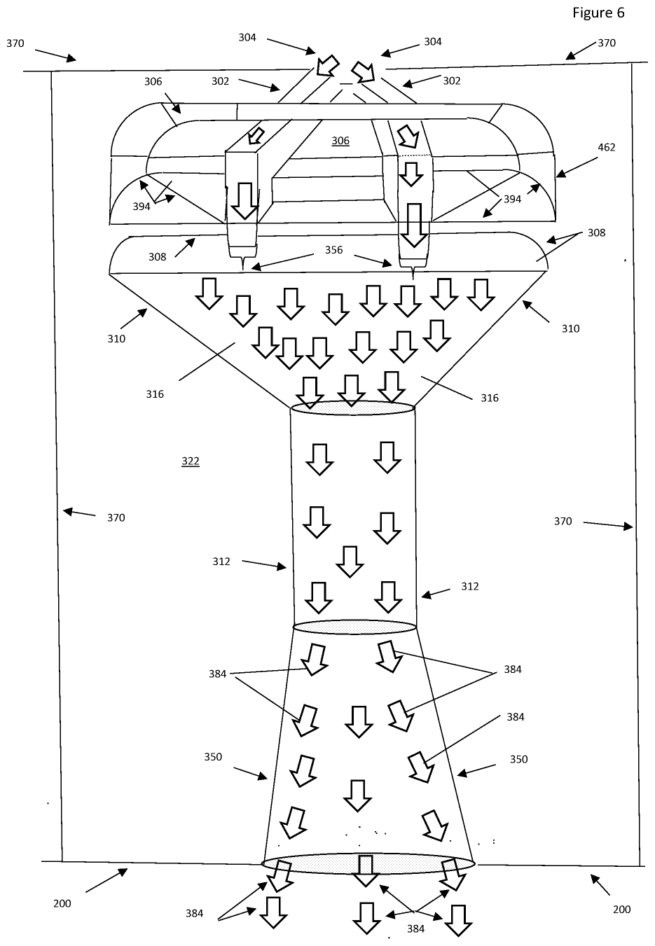

In another embodiment of FIG. 5, in FIG. 6, the secondary bladder and pneumatic air flow control apparatus (394) is constructed as an apparatus separate and apart from the Convergent Divergent Nozzle Subsystem itself (322). Here, the pneumatic air out flow line (302) of the second pneumatic air bladder (464) passes through the posterior section of the secondary bladder and pneumatic air flow control apparatus housing (394), into the convergent section (310) of the Convergent Divergent propulsion subsystem nozzle. As illustrated in FIG. 5, compressed ambient air flows from the primary bladder (not shown), is ejected through the pneumatic air flow apparatus (304) into the secondary bladder (306), the pneumatic air solenoid that exits within the convergent section (310) of the Convergent Divergent Propulsion System Nozzle as a high-pressure low-velocity air flow (316), then flowing through the throat section (312) of the Convergent Divergent Propulsion System Nozzle, thereafter through and exiting the divergent section (350) of the Convergent Divergent Propulsion System Nozzle as a low-pressure high-velocity air flow (384) to the ambient environment, creating thrust and lift.

Convergent-Divergent Concentric Propulsion Nozzle Subsystem

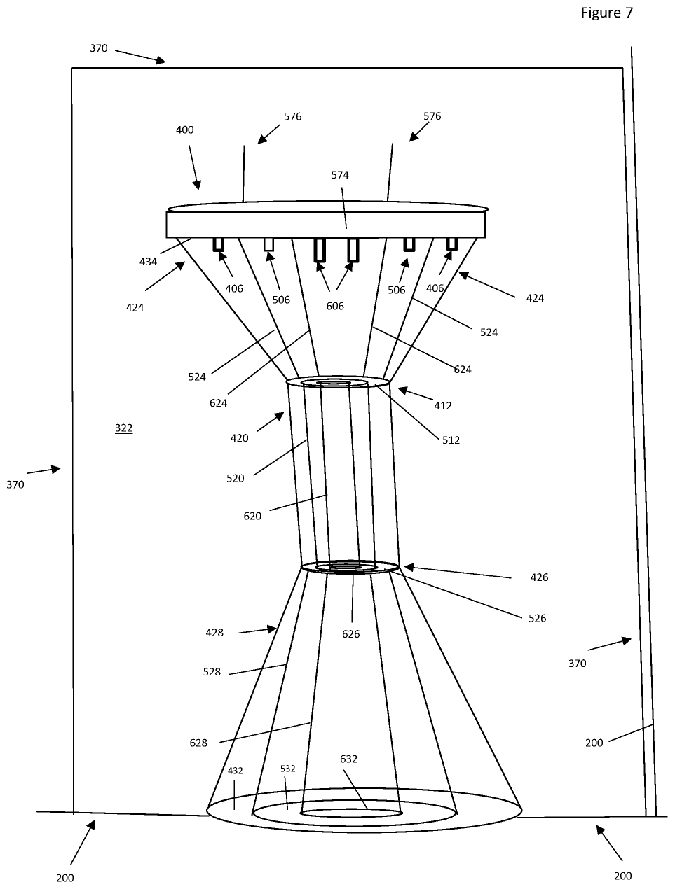

In another embodiment of FIG. 5, FIG. 7 is a concentric Convergent-Divergent propulsion subsystem nozzle (322) with an interior Convergent-Divergent propulsion subsystem nozzle (624) that is coaxially disposed within the middle Convergent-Divergent propulsion subsystem nozzle (524), ejected through the Interior Convergent-Divergent propulsion subsystem nozzle (624) that is coaxially disposed within the exterior of the Convergent Divergent Propulsion Subsystem Nozzle (424). The interior Convergent-Divergent propulsion subsystem nozzle (624) is the primary Convergent-Divergent propulsion subsystem nozzle. The middle Convergent-Divergent propulsion subsystem propulsion subsystem nozzle (524) is coaxially disposed within an exterior Convergent-Divergent propulsion subsystem nozzle (424). The propulsion subsystems (424, 524, 624) of this invention, FIG. 7, are fitted with a secondary bladder and pneumatic air flow control apparatus to supply pneumatic air under pressure to the Convergent-Divergent propulsion subsystems nozzle and is connected to each Convergent Divergent Propulsion subsystem nozzle (624 or 524 or 424). The interface of the Convergent-Divergent propulsion subsystem nozzle with the secondary bladder and pneumatic air flow control apparatus subsystems is denoted at 434. To increase the flow of air, and the resulting increase of thrust and lift, without a significant increase in the number or masse of Convergent Divergent Propulsion System Nozzle. FIG. 7, another embodiment of FIG. 5, a Convergent Divergent Propulsion System Nozzle array is proposed, reducing the footprint of the propulsion system compared to the use of tandem, ganged, or serial propulsion systems. At the same time the increase of propulsion thrust is achieved by concentrating the same air space. In this embodiment, FIG. 7, a single secondary bladder (400) and its pneumatic air flow control apparatus (574) is fitted to the anterior of the Convergent Divergent Propulsion System Nozzle (434) convergent sections (424, 524, 624). Each concentric convergent nozzle section (424, 524, 624) is fitted with its own pneumatic air injection line and solenoid with an air backflow preventer (406, 506, 606) extending from the secondary bladder (400) is, connected to a primary bladder (not shown here) by pneumatic air outflow lines or ducts (576). The interior concentric propulsion nozzle system further consists of the convergent section (624), the throat section (620), the divergent section (628), and the exit section of the divergent section (632). The middle concentric propulsion nozzle system further consists of the convergent section (524), the throat section (520), the divergent section (528), and the exit section of the divergent section (532). The exterior concentric propulsion nozzle system further consists of the convergent section (424), the throat section (420), the divergent section (428), and the exit section of the divergent section (432). The concentric sections (624, 524, 424) of the Convergent Divergent Propulsion System Nozzle (322) is connected to the throat section (612, 512, 412). The throat section (620, 520, 420) of the Convergent Divergent Propulsion System Nozzle (322) is connected to (626) to the divergent section (628, 528, 428) at 626, 526, 426, respectively. In this embodiment the volume of air injected to the respective concentric propulsion nozzle through the solenoid serving same by controlling the rate in which its ball, needle, or butterfly valve is opened, independently or in combination, as controlled by the Command Module's algorithm (not shown) determining thrust and lift requirements, wind speeds and direction, operational requirements of the vehicle.

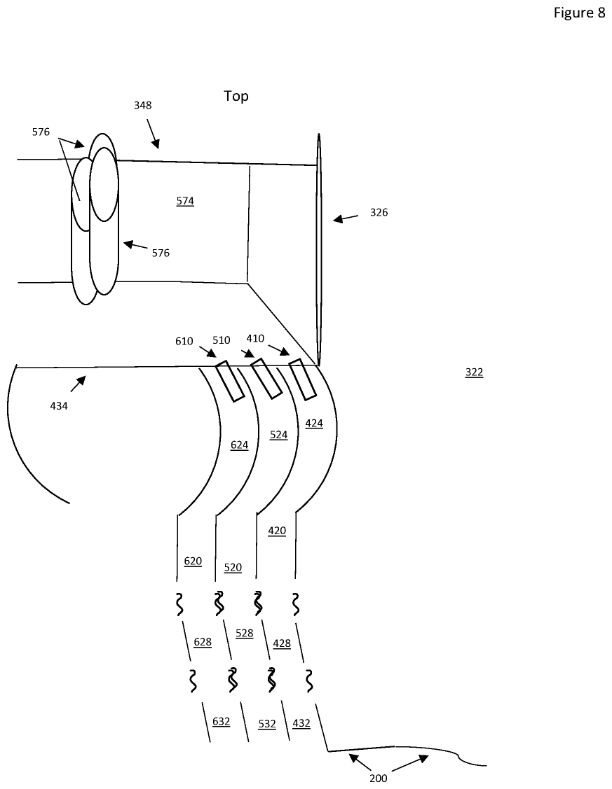

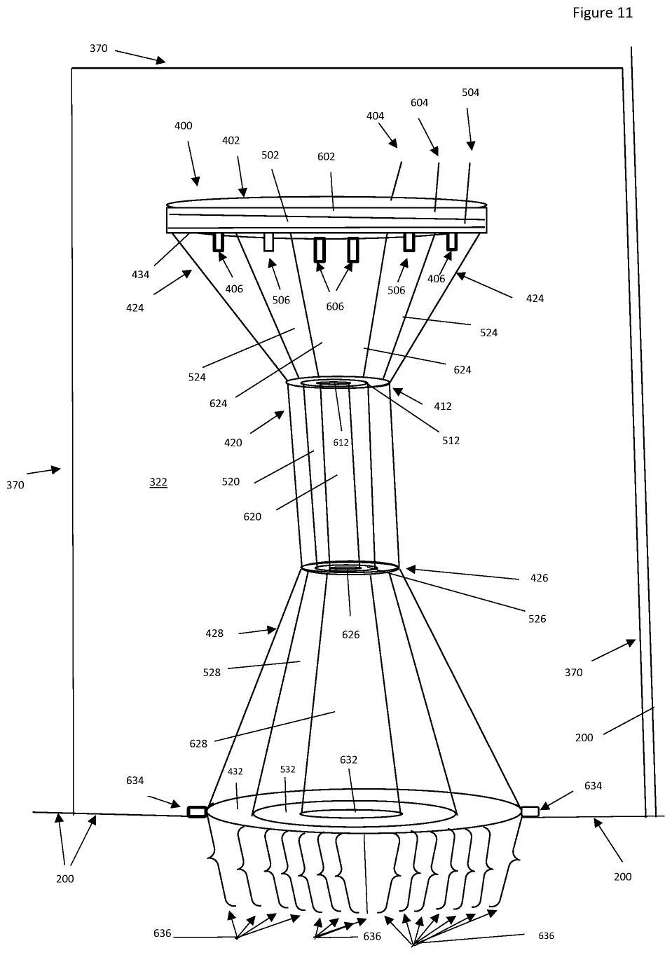

In still another embodiment of FIG. 7, FIG. 8, is a frontal, partial cut-away view of a concentric Convergent Divergent Nozzle propulsion subsystem. Starting from the top (TOP) of FIG. 11 and in a vertically descending direction from the exterior surface (348) of the secondary bladder (326) where an independent pneumatic air flow control apparatus subsystem (574) is connected to out flow ducts or lines (576) that extend from a primary bladder (not shown) to and into a designated pneumatic air flow control apparatus (348), the secondary bladder that is a part of the Convergent Divergent Nozzle propulsion subsystem. Separate air out flow injection lines (410, 510, 610) extend from the pneumatic air flow control apparatus (574), through the interface of the pneumatic air flow control apparatus (434), terminating at or within the convergent section of the Convergent Divergent Nozzle propulsion subsystem (624, 524, 424). Each pneumatic out-flow air line is equipped with air backflow preventer solenoids (not shown). With sufficient air pressure within the convergent section (424, 524, 624) of the Convergent Divergent Nozzle, High-pressure Low-velocity air will flow into and through the throat (420, 520, 620) Convergent Divergent Nozzle, into the divergent section (428, 528, 628) Convergent Divergent Nozzle, as a Low-Pressure High Velocity air flow, thereafter exiting (432, 532, 632) the Convergent Divergent Nozzle to the external environment.

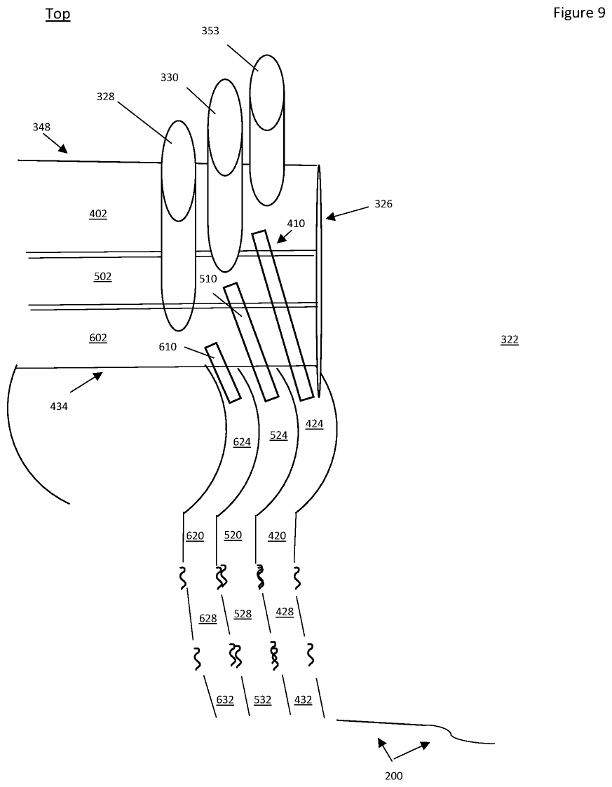

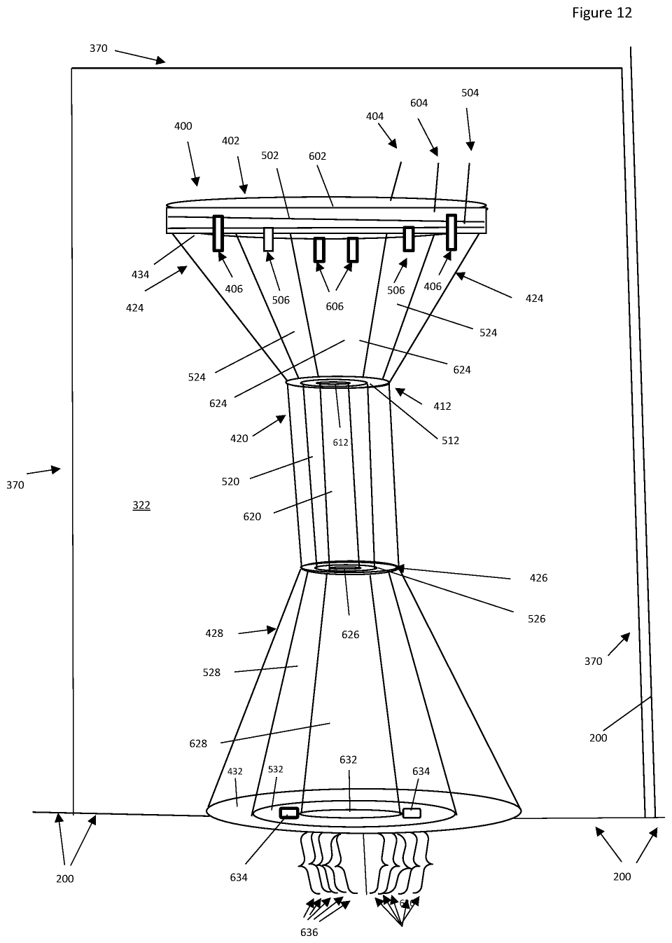

In yet another embodiment of FIG. 8, FIG. 9 depicts a frontal, partial cut-away view of a Concentric Convergent Divergent Nozzle propulsion subsystem. Starting from the top of FIG. 12 and in a vertically descending direction from the exterior surface (348) of the secondary bladder (348) where independent pneumatic air flow control apparatus (574) subsystems (402, 502, 602) are connected by pneumatic out flow ducts or lines (328, 330, 353) that extend from a primary bladder (not shown) to and into a designated pneumatic air flow control apparatus (402, 502, 602). Separate pneumatic air out flow injection lines (410, 510, 610) extend from the pneumatic air flow control apparatus (574), through the interface of the pneumatic air flow control apparatus (434), terminating at or within the convergent section of the Convergent Divergent Nozzle propulsion subsystem (624, 524, 424). Each out-flow pneumatic air line is equipped with air backflow preventer solenoids (not shown). With sufficient air pressure within the convergent section (424, 524, 624) of the Convergent Divergent Nozzle, High-pressure Low-velocity air will flow into and through the throat (420, 520, 620) of the Convergent Divergent Nozzle propulsion subsystem, into the divergent section (428, 528, 628) of the Convergent Divergent Nozzle propulsion subsystem, thereafter exiting (432, 532, 632) the Convergent Divergent Nozzle to the external environment.

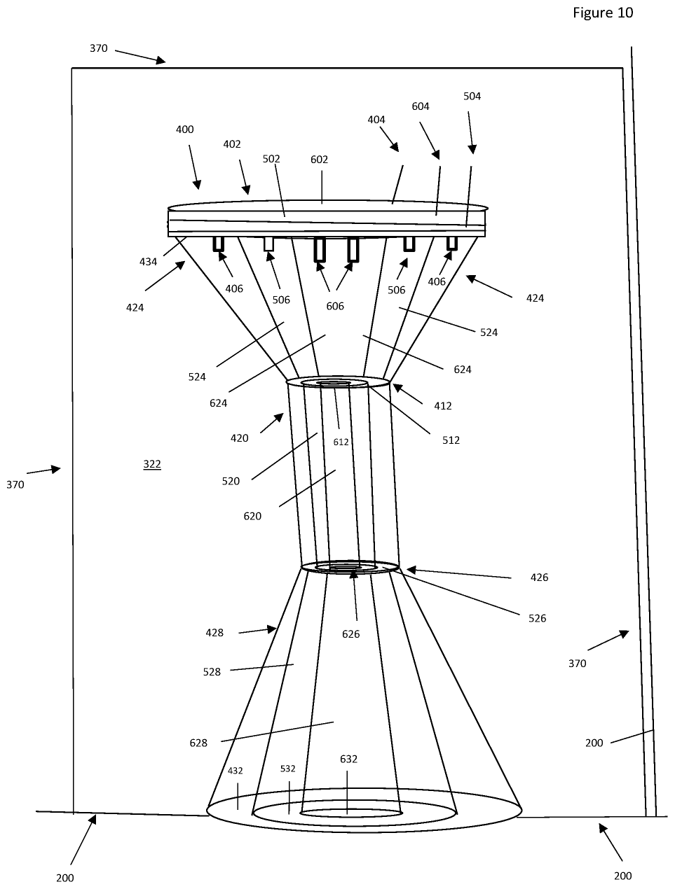

As another embodiment of FIG. 7, FIG. 10, contains multiple secondary bladders (402, 502, 602) and pneumatic air flow control apparatus, secondary pneumatic are bladder (400) and its pneumatic air flow control apparatus (574) which services the middle Convergent Divergent Propulsion subsystem nozzle (624), is connected with its own pneumatic air ejection line with an air backflow preventer (606). The pneumatic air flow control apparatus (502) services the interior Convergent Divergent Propulsion subsystem nozzle (524), is connected with its own pneumatic air ejection line with an air backflow preventer 506). The pneumatic air flow control apparatus (502) services the exterior Convergent Divergent Propulsion subsystem nozzle (424), is connected with its own pneumatic air ejection line and solenoid with an air backflow preventer (406). Each secondary bladder (402, 50, 602) and pneumatic air flow control apparatus that are independently operated by the Command Module. The Command Module controls and can vary air compression, pneumatic air flow, and the resulting volume of and pressure of air injected into the convergent section of each concentric Convergent-Divergent propulsion subsystem nozzle.

Each secondary bladder (402, 502, 602) is separately fitted to a pneumatic air out flow line (402, 502, 602) with a pneumatic air backflow preventer (406, 506, 606) that extends from the primary bladder that when activated will open the orifice of the backflow preventer of the solenoid to pass a compressed volume of air under pressure into the respective secondary bladder. Pressurized air is pushed from the pneumatic air flow control apparatus of the secondary bladder to its connected Convergent-Divergent propulsion subsystem nozzles, through an pneumatic air line(s) fitted with a pneumatic air backflow preventer (406, 506, 606). Air injected by the pneumatic air flow control apparatus of the secondary bladder (424) through its pneumatic air line (406) to create a High-pressure Low-velocity air flow, that with continued injection of air into the convergent section (424), flows through the exterior Convergent-Divergent propulsion subsystem nozzles throat (420) to its exterior Convergent-Divergent propulsion subsystem nozzle section (428) before exiting the divergent section (428), creating thrust as it exits the Convergent-Divergent propulsion subsystem nozzle section (428), in conjunction with the exiting air flow from the Convergent-Divergent propulsion subsystem nozzle divergent sections (528, 628). Respectively, air entering the middle compression follows the same air flow pattern through the middle Convergent-Divergent propulsion subsystem (524, 528, 532). Air entering through the pneumatic air line (404, 504, 604) from the primary bladder (not shown) into the exterior, middle, and interior pneumatic air flow control apparatus of the secondary bladder follows the same flow pattern as air flows through the exterior, interior, and middle Convergent-Divergent propulsion subsystem (606, 612, 620, 624, 632), respectively.

The concentric Convergent-Divergent propulsion system concentrates the exit flow of Low-pressure High-velocity air of three Convergent-Divergent propulsion systems into one space, with a smaller subsystem footprint than what can be achieved with a linear array of individual propulsion subsystem nozzles or other propulsion subsystems to increase thrust, lift and stabilization, particularly in an environment with multiple, competing, adverse wind patterns, where 720° situational awareness and rapid maneuverability adjustments are requisite not the exception.

In another embodiment of FIG. 8, FIG. 11, which is a variant of the embodiment of FIG. 8, depicts an embodiment that is fitted with a Command Module controlled MEM (634) connected variable nozzle (636), that when activated will cause the variable nozzle (636) to constrict, changing the velocity and pressure of the joint flow of air exiting the exterior concentric Convergent-Divergent nozzle subsystem (428, 432) to produce an increase in thrust. While not intended to be limited in scope, the Convergent Divergent Propulsion subsystem nozzle here is fitted with multiple, independently controlled secondary bladders and pneumatic air flow control apparatus.

In another embodiment of FIG. 9, In FIG. 12, there is shown the interior divergent section of the concentric Convergent-Divergent nozzle (632) fitted with a Command Module controlled MEM (634) connected variable nozzle (636), that when activated will cause the nozzle (636) to constrict, increasing thrust by changing the velocity and pressure of air exiting the primary concentric Convergent-Divergent nozzle (628) to the external environment.

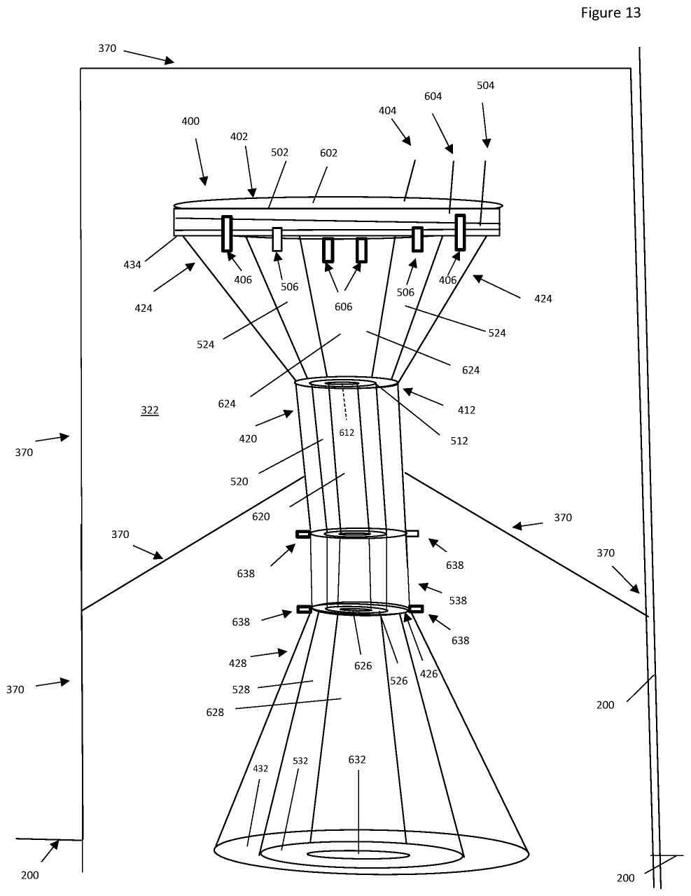

In another embodiment of FIG. 12, the throat of the concentric Convergent-Divergent propulsion subsystem nozzle of the embodiment of FIG. 13 is fitted with a Command Module controlled MEM (638) connected flexible extension nozzle (538), that when activated will cause the flexible extension nozzle (538) to change the pitch and rotation of the divergent section of the concentric Convergent-Divergent nozzle subsystem (and, correspondingly where attached to a single non-concentric Convergent-Divergent nozzle), thereby changing the angle and direction of thrust exiting the Convergent Divergent nozzle to the external environment.

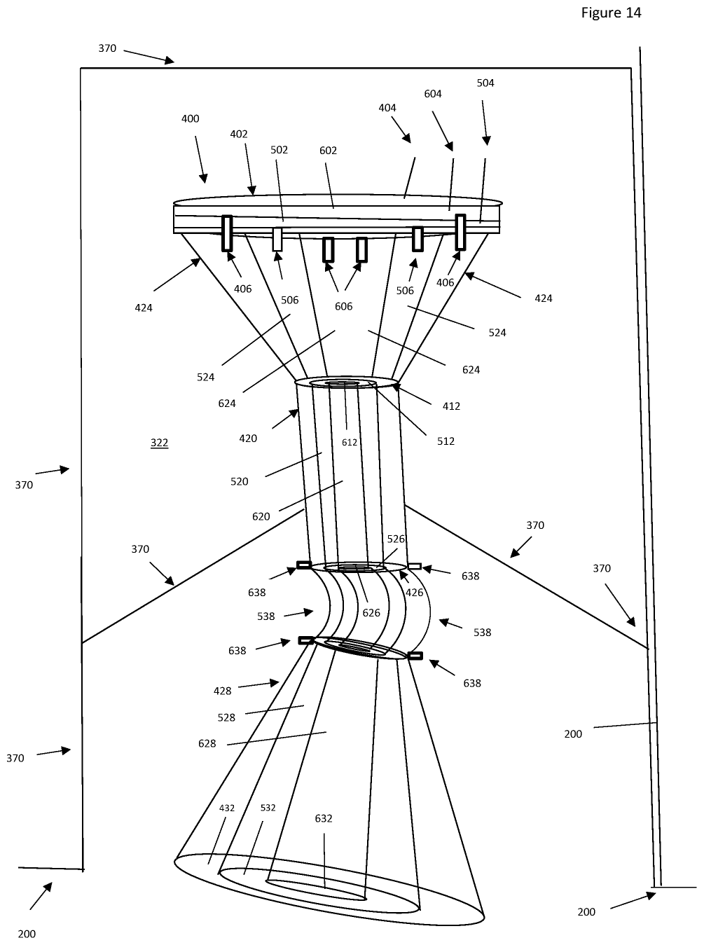

In another embodiment of FIG. 8, FIG. 14, a variant of embodiment FIG. 13, the concentric Convergent-Divergent nozzle Command Module controlled MEM (638) is connected to the flexible extension nozzle (538), that when activated will cause the flexible extension nozzle (538) to change its pitch and rotation of the divergent section of the concentric Convergent-Divergent nozzle subsystem.

An alternative consideration to the flexible extension nozzle is to affix a gimbal (not shown) to a propulsion nozzle array that when activated by the Command Module will change the orientation of the propulsion nozzle array itself.

Bypass Propulsion Nozzle Subsystem

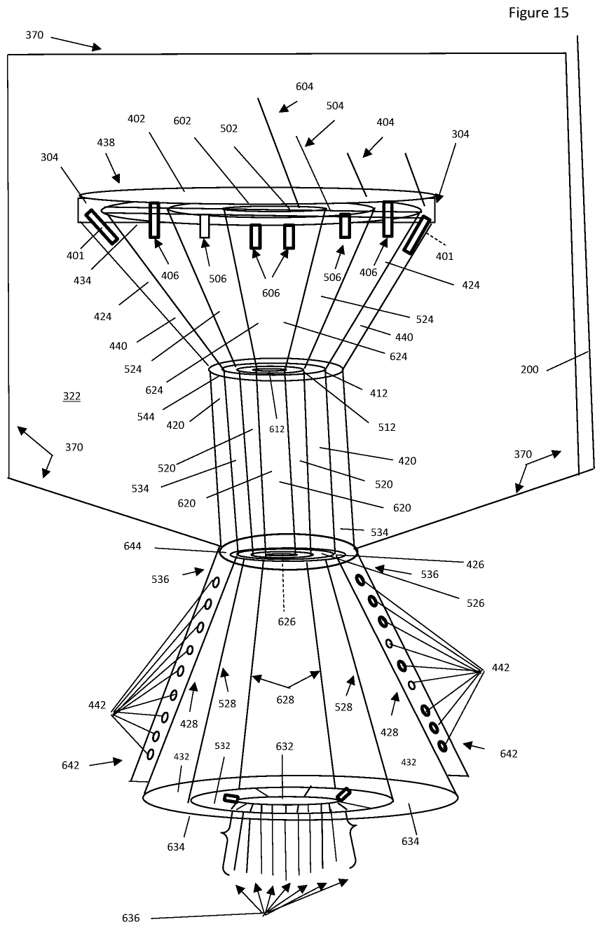

In another embodiment of FIG. 10, FIG. 15 demonstrates an additional pneumatic air flow control apparatus and propulsion nozzle subsystem (304, 401, 436, 540, 544, 644, 536, 642) is added to the concentric Convergent Divergent Nozzle subsystem. When the bypass subsystem is Command Module activated air is ejected through the designated pneumatic air flow control apparatus ducts or lines (436, 534, 536) that bypass the concentric Convergent Divergent (exterior [424, 420, 428] middle [524, 520, 528], interior [624, 620, 628]) nozzles to perform the yaw function during propulsion of the aerial vehicle, by pulse jetted air or continuous stream of ejected compressed air. Air ejected through the bypass nozzles (442) is controlled by the Command Module independently from the Command Module controlled air compressors of the concentric Convergent Divergent nozzles of the Propulsion Subsystem.

In another embodiment of FIG. 10, FIG. 15 shows the air flow pattern (609) from the point of compressed air entering the pneumatic air outflow lines from the secondary bladder and attached pneumatic air flow control apparatus, passing through the respective individual concentric Convergent Divergent Nozzle subsystem pneumatic air flow control apparatus, convergent nozzle section, throat, divergent nozzle section, then exiting the nozzle, and through the pneumatic air flow control apparatus subsystem for the bypass nozzle subsystem to the bypass air ejection nozzles. Here, the bypass subsystem (436) is a fourth nozzle structure of the concentric Convergent Divergent Nozzle propulsion subsystem.

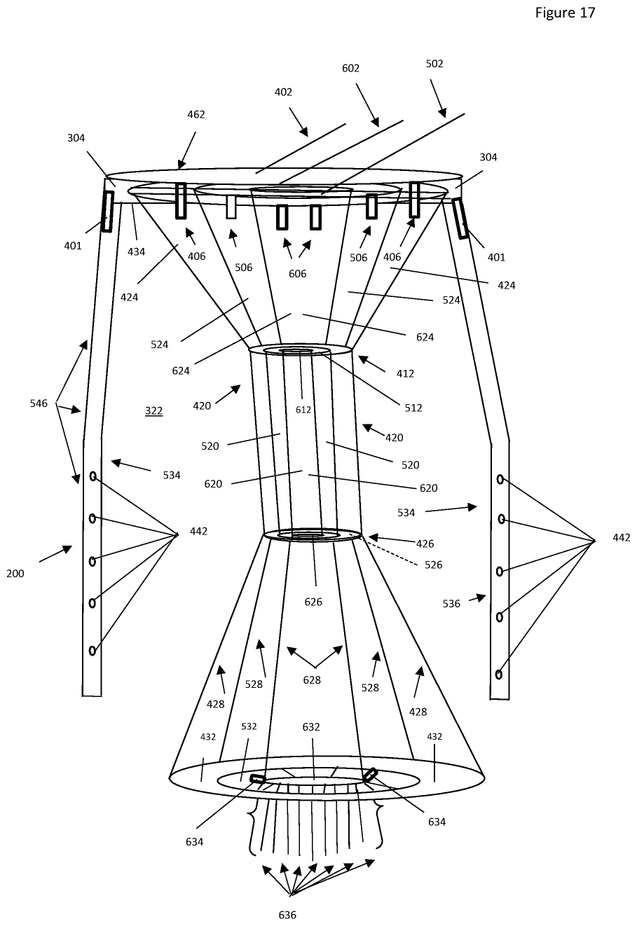

In another embodiment of FIG. 10, the bypass nozzles (436) of FIG. 17 are incorporated into the exterior surface (200) of the vehicle. A bypass pneumatic air line (546) connects the bypass pneumatic air flow control apparatus (304) to the bypass ejection nozzle subsystem (436).

In another embodiment of FIG. 17, the bypass pneumatic air ejection nozzles subsystem (436) are integrated into the exterior surface (200) of the vehicle. When the Command Module activated compressed air in the secondary bladder and pneumatic air flow control apparatus subsystem is ejected through the pneumatic air line (401) into the bypass pneumatic nozzle subsystem (546), thereafter exiting the pneumatic bypass subsystem air ejection nozzle subsystem (436), to the external or ambient environment.

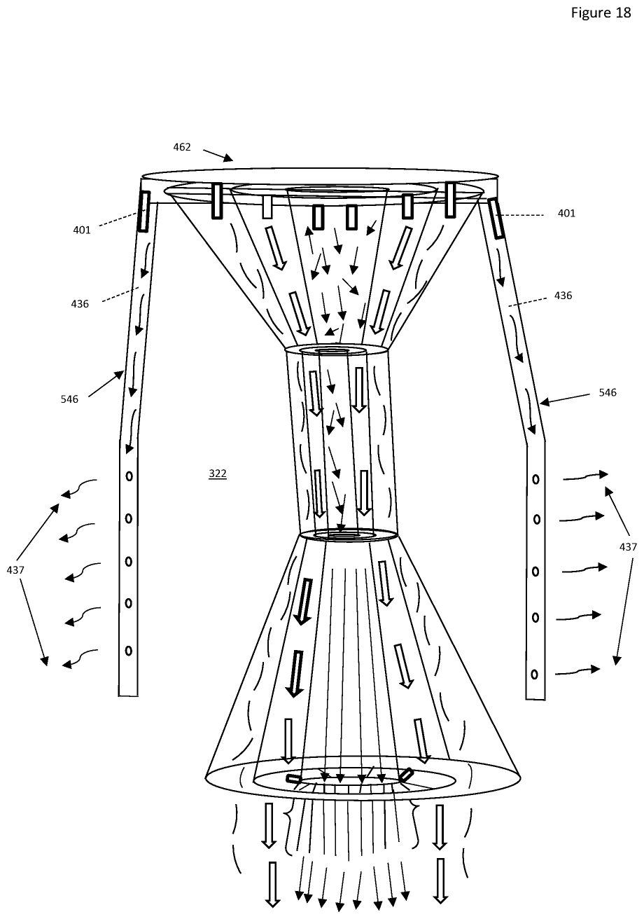

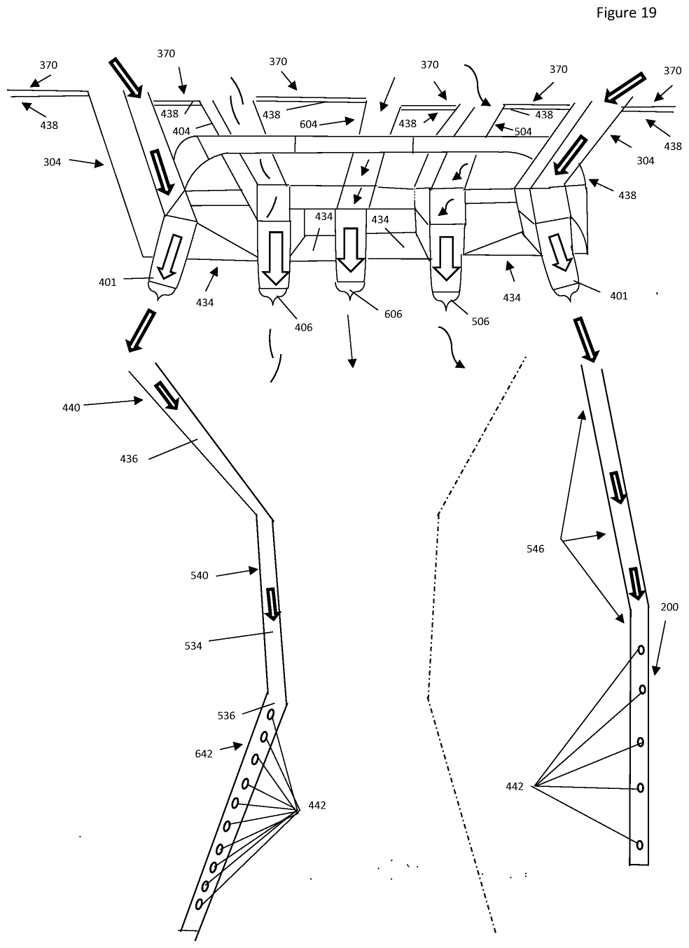

In In another embodiment of FIG. 18, FIG. 19 shows a frontal, partial cut-a-way composite view of the nozzle's pneumatic air flow control apparatus (438) separated from the concentric Convergent Divergent Nozzle propulsion subsystem. The bypass ducts or lines (440, 540, 642) contiguous to the Convergent Divergent Nozzle array (424, 420, 428) is displayed to the left side of FIG. 18.

The bypass pneumatic air line subsystem (546) that is extended through the exterior surface of the vehicle (200), separated from the Convergent Divergent Nozzle array, and extended through the exterior surface of the vehicle (200), is displayed to the right side of the FIG. 19.

It may be required that the nozzle for the primary or main drive of a concentric Convergent

Divergent propulsion nozzle for lift and thrust is larger than what is required by a bypass nozzle or propulsion nozzle array designed primarily for roll, pitch, and yaw flight functions.

The air bypass system of FIGS. 61, 17, 18, and 19 can be fitted to propulsion subsystems other than the concentric Convergent Divergent Nozzle systems.

Electric Fan Propulsion Nozzle Subsystem

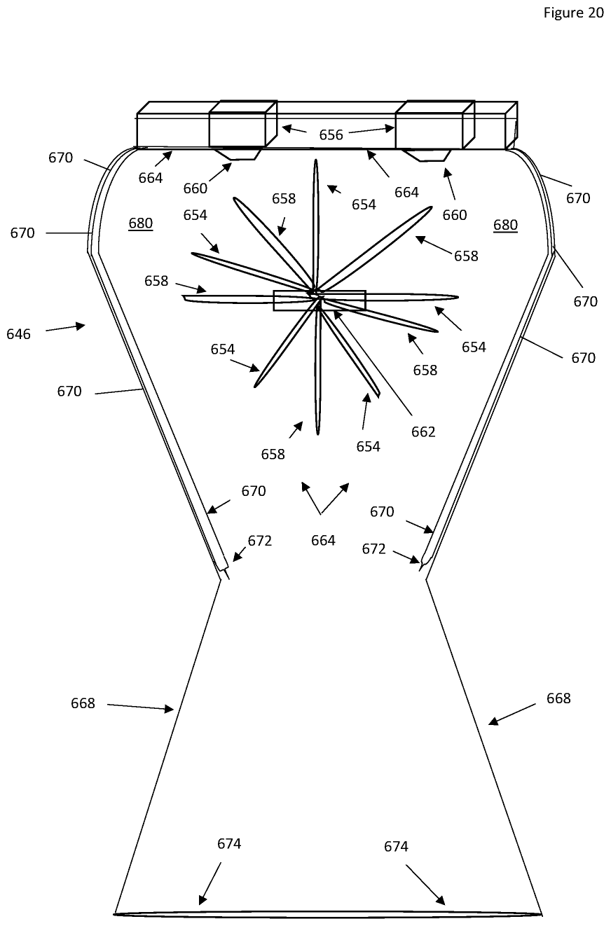

In an embodiment, FIG. 20 shows a propulsion nozzle (646) with counter-rotating electric fan blades (654, 658) fitted to an electric motor within the interior of the convergent section (664). The electric fan blades (654, 658) and its electric motor (662), shrouded from the external environment. Air is injected into the convergent section (664) of the nozzle anterior (680) to the fan blade and electric motor assembly (654, 658), through a Command Module controlled air solenoid (660) from the pneumatic air flow control apparatus (656). Additionally, air from the nozzle's pneumatic air flow control apparatus (656) is sent through a pneumatic outflow line (670) to a pneumatic air solenoid (660) below the fan blade assembly (654, 658, 662). Air introduced to the area above or ahead of the counter rotating fan blade assembly (654, 658) is then accelerated by the electric fan, increasing the exit speed to create thrust, lift, or both thrust and lift, while compressed air introduced below the electric fan assembly is to increase thrust output.

By changing the size of the orifice of the air solenoid opening controlled by the Command Module the resulting velocity and pressure of entrained air can be increased or decreased.

By incorporating the counter-rotating fan assembly (654, 658) within the nozzle array (646) the blades are shrouded from objects and debris common to a fire environment.

The nozzle enclosed electric fan subsystem (654, 658, 662) can be housed within a convergent divergent nozzle and other nozzle configurations.

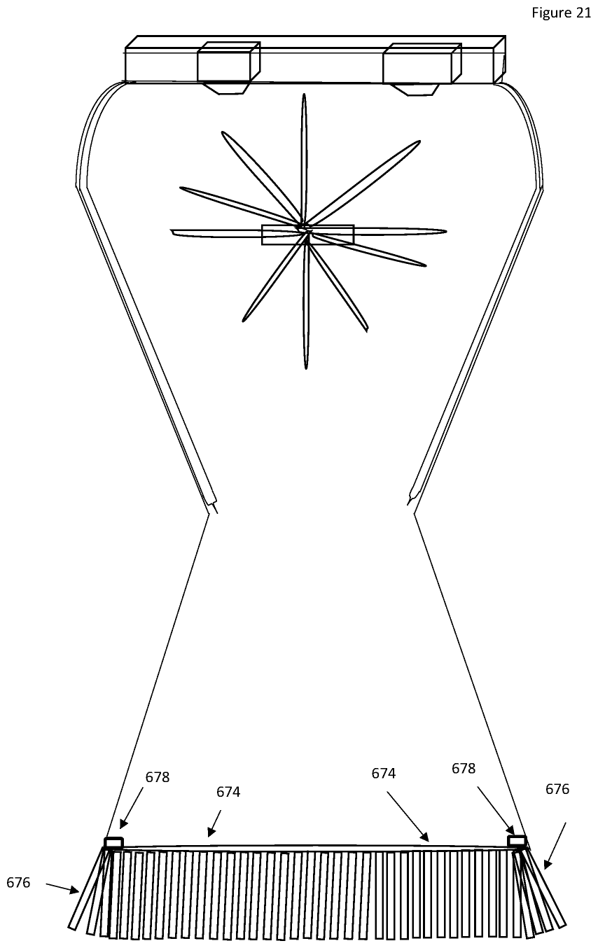

In another embodiment of FIG. 20, FIG. 21 is fitted with a MEM (678) controlled variable nozzle (676), that when activated by the Command Module will constrict, narrowing the air exhaust (674) exiting the Convergent Divergent nozzle (668), increasing thrust.

An alternate method to provide a high volume of ambient air to a propulsion subsystem nozzle, independent of or in conjunction with the compressed air subsystem, is to install a Command Module that controls the propulsion subsystem secondary air pump(s). The propulsion subsystem secondary air pumps are connected with the Command Module controlled secondary pneumatic air intake lines that extend to and through the surface of the vehicle, and one or more pneumatic air outflow ducts or lines that extend to and terminate within a propulsion nozzle subsystem. When activated, the propulsion subsystem secondary air pump(s) will cause a high volume of ambient air to flow into the convergent section of a propulsion nozzle subsystem.

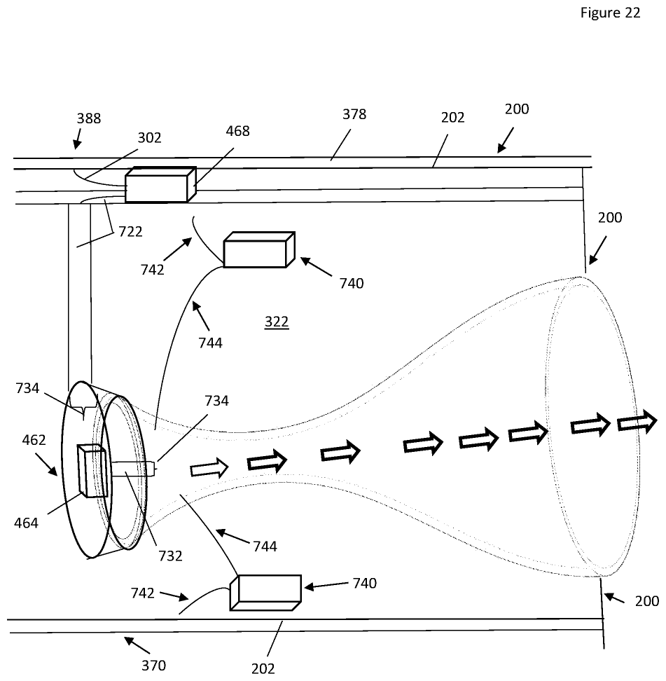

In an embodiment, FIG. 22 shows that when the Control Module activates the secondary pneumatic air pump subsystem (740) the Control Module opens a ball, needle, or butterfly valve of the pneumatic air intake line(s) (742) that connect the propulsion subsystem secondary air pump(s) to the surface of the vehicle (200) to cause the transfer of ambient air into the secondary air pump subsystem (740). Having activated the pneumatic air outflow line(s) (744) of the propulsion subsystem secondary air pumps with its air backflow solenoid exiting within a propulsion nozzle subsystem (322), opening the solenoid's ball, needle, or butterfly valve for a high volume of ambient air to effect a continuous or intermittent flow into the convergent section (310) of the propulsion subsystem nozzle creating a high-volume, low velocity flow of air within the convergent section of the propulsion subsystem nozzle, with the rate of flow and volume of air regulated by the Command Module. The interior diameter of the propulsion subsystem secondary pneumatic air pump intake ducts or lines (752) should be wider than the interior diameter of the outflow ducts or lines (744).

The secondary air pump subsystem and its components (740, 742, 744) can be applied to the concentric Convergent Divergent nozzle subsystems (not shown here) and the propulsion subsystem with the electric fan assembly (not shown here) as well.

It will be apparent to those skilled in the art that various modifications and variations can be made without departing from the scope or spirit of the invention. Other embodiments will be apparent to those skilled in the art from consideration of the specifications and practice disclosed herein. It is intended that the specification and examples be considered as exemplary only, with a true scope and spirit being indicated by the following claims.

An internal channel (not shown) may be included within the compressor design that enables circulation of a coolant or storage of a phase change material to enable the compressor apparatus to operate at a reduced temperature for a longer period.

Component Chart

| | |
|---|---|
| Surface of the vehicle | 200 |
| Aerial vehicle | 300 |
| Pneumatic air intake line | 302 |
| Pneumatic air flow control apparatus | 304 |
| Pneumatic air flow control apparatus | 306 |
| Secondary bladder and air flow control apparatus | 308 |
| Convergent section of the nozzle | 310 |
| Throat section of the Convergent Divergent Propulsion Nozzle | 312 |
| Compressed ambient air ejected through the solenoid | 316 |
| High-pressure Low-velocity flow | 316 |
| Pneumatic air intake lines | 320 |
| Convergent Divergent Propulsion Subsystem | 322 |
| Low pressure high velocity air flow | 324 |
| Pneumatic air flow control apparatus | 326 |
| Secondary bladder | 326 |
| Pneumatic out flow ducts or lines | 328 |
| Pneumatic out flow ducts or lines | 330 |
| Exterior surface of the secondary bladder | 348 |
| Divergent section of the Convergent Divergent Propulsion Nozzle | 350 |
| Basic outline of a Convergent Divergent Nozzle | 352 |
| Pneumatic out flow ducts or lines | 353 |
| Solenoid Backflow Air Preventer | 356 |
| Connected section of the throat | 358 |
| Housing system of the Convergent Divergent Nozzle subsystem | 370 |
| Pneumatic air solenoid | 372 |
| Air backflow preventer | 374 |
| Primary air pneumatic bladder | 378 |
| Low-pressure High-velocity (384) air flow | 384 |
| Entering ambient air | 388 |
| Throat section connected to the divergent section of the | 390 |
| Convergent Divergent Propulsion Nozzle subsystem | |
| Low-pressure high velocity air flow | 392 |
| Pneumatic air flow control apparatus | 394 |
| Bottom, right section, of the aircraft | 398 |
| Bottom, left section, of the aircraft | 399 |
| Secondary air pneumatic bladder | 400 |
| Secondary air pneumatic bladder | 402 |
| Pneumatic air line from the primary bladder to the secondary air | 404 |
| pneumatic bladder | |
| Pneumatic air injection line and solenoid with an air backflow | 406 |
| preventer | |
| Air out flow injection lines | 410 |
| Concentric nozzle exterior throat connection to the exterior | 412 |
| convergent section of the nozzle | |
| Concentric throat section of the Convergent Divergent Propulsion | 420 |
| System Nozzle | |
| Exterior Convergent-Divergent propulsion subsystem nozzle | 424 |
| coaxially disposed within the exterior Convergent Divergent | |
| Propulsion subsystem nozzle | |
| The throat section of the Concentric Convergent Divergent | 426 |
| Propulsion System Nozzle is connected to the concentric divergent | |
| section | |
| Pneumatic air compressors | 468 |
| Middle concentric propulsion nozzle system | 428 |
| Exit section of the divergent section | 432 |
| Pneumatic air flow control apparatus fitted to the CDN | 434 |
| Bypass nozzle subsystem | 436 |
| Air exit flow from the bypass nozzle system | 437 |
| Pneumatic air flow control apparatus | 438 |
| Bypass ducts or lines | 440 |
| Bypass nozzles | 442 |
| Fuselage, top left side of the circular wing aerial vehicle | 446 |
| Fuselage, top right side of the circular wing aerial vehicle | 448 |
| Command Module controlled onboard electric generators | 450 |
| Fire suppression subsystems | 452 |
| Fire suppression subsystems | 454 |
| Fire suppression subsystems | 456 |
| Fire suppression subsystems | 458 |
| Top view | 460 |
| Secondary bladder | 462 |
| Pneumatic air flow apparatus | 464 |
| Primary pneumatic air compressors | 468 |
| Secondary air pneumatic bladder | 502 |
| Pneumatic air line from the primary bladder to the secondary air | 504 |
| pneumatic bladder | |
| Pneumatic air injection line and solenoid with an air backflow | 506 |
| preventer | |
| Air out flow injection lines | 510 |
| Concentric nozzle exterior throat connection to the exterior | 512 |
| convergent section of the nozzle | |
| Concentric throat section of the Convergent Divergent Propulsion | 520 |
| System Nozzle | |
| Middle Convergent-Divergent propulsion subsystem nozzle | 524 |
| coaxially disposed within the exterior Convergent Divergent | |
| Propulsion subsystem nozzle | |
| The throat section of the Concentric Convergent Divergent | 526 |
| Propulsion System Nozzle is connected to the concentric divergent | |
| section | |
| Middle concentric propulsion nozzle system divergent section | 528 |
| Exit section of the divergent section | 532 |
| Pneumatic air flow control apparatus ducts or lines that bypass the | 534 |
| concentric Convergent Divergent nozzles of the Propulsion | |
| Subsystem. | |
| Additional pneumatic air flow control apparatus and propulsion | 536 |
| nozzle subsystem | |
| Bypass subsystem | 536 |
| Flexible extension nozzle | 538 |
| Bypass ducts or lines | 540 |
| Bypass ducts or lines | 544 |
| Bypass pneumatic air ejection nozzles | 546 |
| Command Module controlled propulsion subsystem | 548 |
| Command Module controlled propulsion subsystem | 550 |
| Command Module controlled propulsion subsystem | 552 |
| Command Module controlled propulsion subsystem | 554 |
| Command Module controlled propulsion subsystem | 556 |
| Command Module controlled propulsion subsystem | 558 |
| Command Module controlled propulsion subsystem | 560 |
| Command Module controlled propulsion subsystem | 562 |
| Command Module controlled propulsion subsystem | 564 |
| Command Module controlled propulsion subsystem | 566 |
| Command Module controlled propulsion subsystem | 568 |
| Command Module controlled propulsion subsystem | 570 |
| Command Module controlled propulsion subsystem | 572 |
| Pneumatic air flow control apparatus | 574 |
| Pneumatic air flow control apparatus subsystem | 576 |
| Secondary air pneumatic bladder | 602 |
| Pneumatic air line from the primary bladder to the secondary air | 604 |
| pneumatic bladder | |
| Pneumatic air injection line and solenoid with an air backflow | 606 |
| preventer | |
| Air out flow injection lines | 610 |
| Concentric nozzle exterior throat connection to the exterior | 612 |
| convergent section of the nozzle | |
| Concentric throat section of the Convergent Divergent Propulsion | 620 |
| System Nozzle | |
| Interior Convergent-Divergent propulsion subsystem nozzle | 624 |
| coaxially disposed within the | |
| exterior Convergent Divergent Propulsion subsystem nozzle | |
| Throat of the Concentric Convergent Divergent Propulsion System | 626 |
| Nozzle | |
| Exterior concentric propulsion nozzle system | 628 |
| Exit section of the divergent section | 632 |
| MicroElectricalMechanical (MEM) systems | 634 |
| MicroElectricalMechanical (MEM) systems | 638 |
| Variable nozzle | 636 |
| Bypass ducts or lines | 642 |
| Bypass ducts or lines | 644 |
| Propulsion nozzle with counter-rotating electric fan blades | 646 |
| Nozzle array | 646 |
| Pneumatic air flow control apparatus | 656 |
| Counter-rotating electric fan | 654 |
| Fan Blade assembly | 654 |
| Electric fan subsystem | 654 |
| Pneumatic air flow control apparatus | 656 |
| Counter-rotating electric fan | 658 |
| Electric fan subsystem | 658 |
| Fan blade assembly | 658 |
| Air solenoid | 660 |
| Electric fan subsystem | 662 |
| Electric motor | 662 |
| Electric fan subsystem | 662 |
| counter-rotating electric fan blades fitted to an electric motor | 664 |
| within the interior of the convergent section | |
| Convergent Divergent nozzle | 668 |
| Pneumatic outflow line | 670 |
| Pneumatic air solenoid | 672 |
| Air exhaust | 674 |
| Variable nozzle | 676 |
| MicroElectricalMechanical (MEM) systems | 678 |
| Convergent section of the nozzle anterior to the fan blade and | 680 |
| electric motor assembly | |
| Pneumatic out-flow line connected to the secondary air pneumatic | 722 |
| bladder | |
| Primary bladder out-flow line | 722 |
| Pneumatic air line that has a backflow preventer | 724 |
| Interface (730) of the secondary bladder | 730 |
| Pneumatic air outflow line | 732 |
| Pneumatic air backflow preventer solenoid | 734 |
| Secondary pneumatic air pump subsystem | 740 |
| Ball, needle, or butterfly valve of the pneumatic air intake line | 742 |
| Pneumatic air outflow line | 744 |
| Interior diameter of the propulsion subsystem secondary pneumatic | 752 |
| air pump intake ducts or lines | |

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A propulsion system for an aerial vehicle, comprising:
a) a first convergent-divergent nozzle, having a convergent section and a divergent section, for ejecting pressurized air to produce thrust to propel the aerial vehicle;
b) a primary bladder, operatively connected to the first convergent-divergent nozzle, for containing pressurized air and releasing the pressurized air into the first convergent-divergent nozzle; and
c) a pneumatic air compressor for pressurizing ambient air into the primary bladder and having an air intake line extending to an exterior surface of the aerial vehicle to receive ambient air and an air outflow line extending to the primary bladder for transferring pressurized air into the primary bladder from the pneumatic air compressor.

2. The propulsion system of claim 1, further comprising a command module, operatively connected to the primary bladder and the pneumatic air compressor, for electronically controlling the pneumatic air compressor and the primary bladder to release pressurized air into the convergent-divergent nozzle, wherein the command module is configured to include processing software components, computer executable instructions, computing devices, one or more system memories with computer readable media in the form of volatile memory, read only memory random-access memory, non-volatile memory, and other removable/non-removable, volatile/non-volatile computer storage media, operating systems, signal selection software, and/or program modules.

3. The propulsion system of claim 1, further comprising a secondary bladder, operatively connected to the primary bladder, and wherein the primary bladder includes one or more pneumatic air outflow lines having an air backflow preventer for preventing backflow between the primary bladder and the secondary bladder.

4. The propulsion system of claim 3 further comprising a pneumatic air flow control apparatus that is independently operated by the command module to vary air compression, air flow, and the resulting volume of and pressure of air injected into the convergent section of the first convergent-divergent nozzle.

5. The propulsion system of claim 1 further comprising a second convergent-divergent nozzle disposed coaxially and concentrically upstream and within an interior of the first convergent-divergent nozzle for ejecting air from the first convergent-divergent nozzle into the second convergent-divergent nozzle.

6. The propulsion system of claim 5, further comprising a second bladder operatively connected to the second convergent-divergent nozzle.

7. The propulsion system of claim 6, further comprising a second pneumatic compressor operatively connected to the second bladder.

8. The propulsion system of claim 7, further comprising:
a) a propulsion nozzle having a convergent section and counter-rotating electric fan blades fitted to an interior of the convergent section of the propulsion nozzle;
b) an electric motor housed within the propulsion nozzle; and
c) a third bladder having pneumatic air outflow lines with air backflow preventers connected to the convergent section of the propulsion nozzle and disposed anterior to the fan blades and electric motor.

9. The propulsion system of claim 8 further comprising a propulsion nozzle system with an electric fan thruster mounted within the propulsion nozzle.

10. The propulsion system of claim 9 further comprising a bypass nozzle system including (a) one or more pneumatic air outflow lines with an air backflow preventer of the secondary bladder and (b) multiple air ejection nozzles to eject air to clear debris from the vehicle or to assist with a change in pitch, roll and yaw of the aerial vehicle.

11. The propulsion system of claim 10 further comprising one or more pneumatic outflow air lines attached to a secondary bladder.

12. The propulsion system of claim 11, further comprising:
a) A variable propulsion nozzle;
b) A first microelectrical mechanical device attached to the variable nozzle for causing the variable propulsion nozzle to constrict;
c) A flexible extension nozzle connected to a throat portion of the convergent-divergent nozzle;
d) A second microelectrical mechanical device attached to the flexible extension nozzle for causing the flexible extension nozzle to change the pitch and rotation of the divergent section of the convergent-divergent nozzle; and
e) A gimbal operatively connected to the command module and affixed to the propulsion nozzle such that when the orientation of the propulsion nozzle is responsive to instructions from the Command Module.

13. The propulsion system of claim 12, wherein the propulsion nozzle is constructed of a heat-resistant material including polypropylene, polyethylene, nylon, olefin, PVC laminated or coated fabric, cloth-back vinyl, thermoplastic films, ethyl vinyl acetate, thermoplastic polyurethane, elastomers, silicon carbides, advanced ceramic materials, C/SiC, SiC/SiC, coated C/C, metal matrix composites, ceramic matrix composites, polymer matrix composites, silicates, silicides, borides, carbides, high-enthalpy alloys, MAX alloys, graphites, graphene, stainless steels, titanium alloys, aluminum alloys, superalloys, steels, wrought alloys, cast alloys, additively manufactured alloys, abradable materials, cermets.

14. The propulsion system of claim 13, wherein the propulsion nozzle includes coatings and surface preparations that change the boundary layer conditions such that environmental attack is not energetically favorable.

15. The pneumatic air line that enters the air flow containment apparatus, coiled or serpentine fashion and of an expandable material, will allow the pneumatic air line to expand as needed to accommodate material expansion resulting from varying temperature and pressure conditions, decompression, and repeated pressurization.

16. The propulsion system of claim 2, wherein the Command Module is electronically or wirelessly linked to Urban Traffic Management systems, Beyond Visual Line of Sight systems, microwave systems, infrared, near-red, LIDAR, GPS, Altimeter, communication systems, gyroscope, collision detection/situational awareness sensors, pressure sensors, geofencing sensors, air pressure relief system, structural integrity monitoring devices, pneumatic air intake, compressor and air flow monitors and control mechanisms, air flow monitor of the convergent divergent nozzle system, flame detection, thermal detection, collision detection and avoidance, internal and external environment temperature monitors, electrical generation and distribution, battery usage and charging, filtration, propulsion systems, microelectrical mechanical systems, thermal storage, thermal transfer, cooling systems, Radio Frequency Identification, flight controllers, accelerometers such that the data therefrom is utilized by the command module to activate and adjust each propulsion system to meet the stability demands required to operate the aerial vehicle.

17. The propulsion system of claim 16, wherein the command module is electronically or wirelessly linked to the accelerometers and gyroscopes housed throughout the aerial vehicle to detect lateral and horizontal motion induced by the turbulent forces within the wildfire.

18. The propulsion system of claim 20, wherein the command module is electronically or wirelessly linked to accelerometers housed throughout the aircraft to determine which propulsion system to energize, and to what amplitude, to achieve the desired thrust magnitude and vector for control of the aerial vehicle.

19. The propulsion system of claim 2, further comprising accelerometers mounted within the wings of the aircraft.

20. The propulsion system of claim 2, further comprising air pressure sensor, air relief valve, and a structural integrity monitor, all of which are operatively connected to the command module electronically or wirelessly linked.
